(19) United States
(12) Patent Application Publication
(10) Pub. No.: US 2013/0263026 A1
(43) Pub. Date: Oct. 3, 2013

(54) DISPLAY CONTROL APPARATUS, DISPLAY CONTROL METHOD, PROGRAM, AND DISPLAY DEVICE

(71) Applicant: SONY CORPORATION, Tokyo (JP)

(72) Inventor: Tsugutomo Enami, Saitama (JP)

(73) Assignee: Sony Corporation, Tokyo (JP)

(21) Appl. No.: 13/787,301

(22) Filed: Mar. 6, 2013

(30) Foreign Application Priority Data
Mar. 30, 2012 (JP) 2012-080990

(51) Int. Cl. G06F 3/0484

(52) U.S. Cl. CPC G06F 3/0484
USPC 715/761

(57) ABSTRACT

There is provided a display control apparatus including a determination part configured to determine whether a display target screen is an entry screen, and a display control part configured to, in a case where the display target screen is determined not to be an entry screen, control a first display device to display the display target screen, and in a case where the display target screen is determined to be an entry screen, control a second display device, which is different from the first display device, to display an entry screen that is identical to or different from the display target screen.

### BACKGROUND

The present disclosure relates to a display control apparatus, a display control method, a program, and a display device.

In recent years, sizes of display devices such as television devices have been increasing. Since such a large-sized display device is capable of displaying display contents in large sizes, the large-sized display device is suitable when multiple viewers look at the same display contents at the same time, for example. However, there is a case where an operator inputs an operation for controlling display contents displayed on a large-sized display device while looking at display contents displayed on a small-sized display device which is provided separately from the large-sized display device.

For example, when the display contents on the large-sized display device and the display contents on the small-sized display device work in association with each other, the operator can confirm the display contents by looking at the small-sized display device instead of the large-sized display device. However, for example, in the case where a password entry screen is included in the display contents, a viewer other than the operator can see the password through the display of display contents on the large-sized display device.

Accordingly, for example, technology is disclosed for controlling display contents of both small-sized display device and large-sized display device by a control apparatus (for example, see JP 2005-345543A). According to the technology, for example, in the case where a password entry screen is included in the display contents, restrictions can be imposed on the display of the display contents on the large-sized display device. With such a control, the situation that the password is seen by a viewer other than the operator can be avoided.

### SUMMARY

In the technology disclosed in JP 2005-345543A, the following is set as a basic state, that is, the state in which display contents are displayed on both large-sized display device and small-sized display device. However, there is a case where the operator also looks at the display contents displayed on the large-sized display device, for example. In that case, the display contents may not be displayed on the small-sized display device.

In light of the foregoing, it is desirable to realize technology for causing a display device to display an entry screen, the display device being different from a display device displaying a screen other than the entry screen.

According to an embodiment of the present disclosure, there is provided a display control apparatus which includes a determination part configured to determine whether a display target screen is an entry screen, and a display control part configured to, in a case where the display target screen is determined not to be an entry screen, control a first display device to display the display target screen, and in a case where the display target screen is determined to be an entry screen, control a second display device, which is different from the first display device, to display an entry screen that is identical to or different from the display target screen.

According to another embodiment of the present disclosure, there is provided a display control method which includes determining whether a display target screen is an entry screen, and in a case where the display target screen is determined not to be an entry screen, controlling a first display device to display the display target screen, and in a case where the display target screen is determined to be an entry screen, controlling a second display device, which is different from the first display device, to display an entry screen that is identical to or different from the display target screen.

According to another embodiment of the present disclosure, there is provided a program for causing a computer to function as a display control apparatus, the display control apparatus including a determination part configured to determine whether a display target screen is an entry screen, and a display control part configured to, in a case where the display target screen is determined not to be an entry screen, control a first display device to display the display target screen, and in a case where the display target screen is determined to be an entry screen, control a second display device, which is different from the first display device, to display an entry screen that is identical to or different from the display target screen.

According to another embodiment of the present disclosure, there is provided a display device which includes a reception part configured to, in a case where a display control apparatus determines that a display target screen is an entry screen, receive from the display control apparatus an instruction to display an entry screen that is identical to or different from the display target screen, and a display part configured to, in a case where the instruction to display the entry screen is received by the reception part, display the entry screen.

According to the embodiments of the present disclosure described above, it is possible to cause a display device to display an entry screen, the display device being different from a display device displaying a screen other than the entry screen.

### BRIEF DESCRIPTION OF THE DRAWINGS

FIG. 1 is a diagram showing a configuration example of a display control system according to a first embodiment;

FIG. 2 is a diagram showing a functional configuration example of a display control apparatus according to the first embodiment;

FIG. 3 is a diagram showing a functional configuration example of a display device according to the first embodiment;

FIG. 4 is a diagram showing an example of functions of the display control apparatus according to the first embodiment;

FIG. 5 is a diagram showing an example of functions of the display control apparatus according to the first embodiment;

FIG. 6 is a diagram showing an example of functions of the display control apparatus according to the first embodiment;

FIG. 7 is a diagram showing an example of functions of the display control apparatus according to the first embodiment;

FIG. 8 is a diagram showing an operation example of the display control apparatus according to the first embodiment;

FIG. 9 is a diagram showing a configuration example of a display control system according to a second embodiment;

FIG. 10 is a diagram showing a functional configuration example of a display control apparatus according to the second embodiment;

FIG. 11 is a diagram showing an example of functions of a selection part according to the second embodiment;

FIG. 12 is a diagram showing an example of functions of the selection part according to the second embodiment;

FIG. 13 is a diagram showing an example of functions of the selection part according to the second embodiment; and

FIG. 14 is a diagram showing an operation example of the display control apparatus according to the second embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Further, in this specification and the appended drawings, there are some cases where multiple structural elements that have substantially the same function and structure are distinguished from one another by being denoted with different alphabets after the same reference numeral. Note that, in the case where it is not necessary to distinguish the multiple structural elements that have substantially the same function and structure from one another, the multiple structural elements are denoted with the same reference numeral only.

Further, the “detailed description of the embodiments” will be described in the following order.

1. First Embodiment
1-1. Configuration Example of Display Control System
1-2. Functional Configuration Example of Display Control Apparatus
1-3. Functional Configuration Example of Display Device
1-4. Description of Functions of Display Control Apparatus
1-5. Operation Example of Display Control Apparatus

2. Second Embodiment
2-1. Configuration Example of Display Control System
2-2. Functional Configuration Example of Display Control Apparatus
2-3. Description of Functions of Display Control Apparatus
2-4. Operation Example of Display Control Apparatus

3. Conclusion

### 1. First Embodiment

First, a first embodiment of the present disclosure will be described sequentially in detail.

<1-1. Configuration Example of Display Control System>

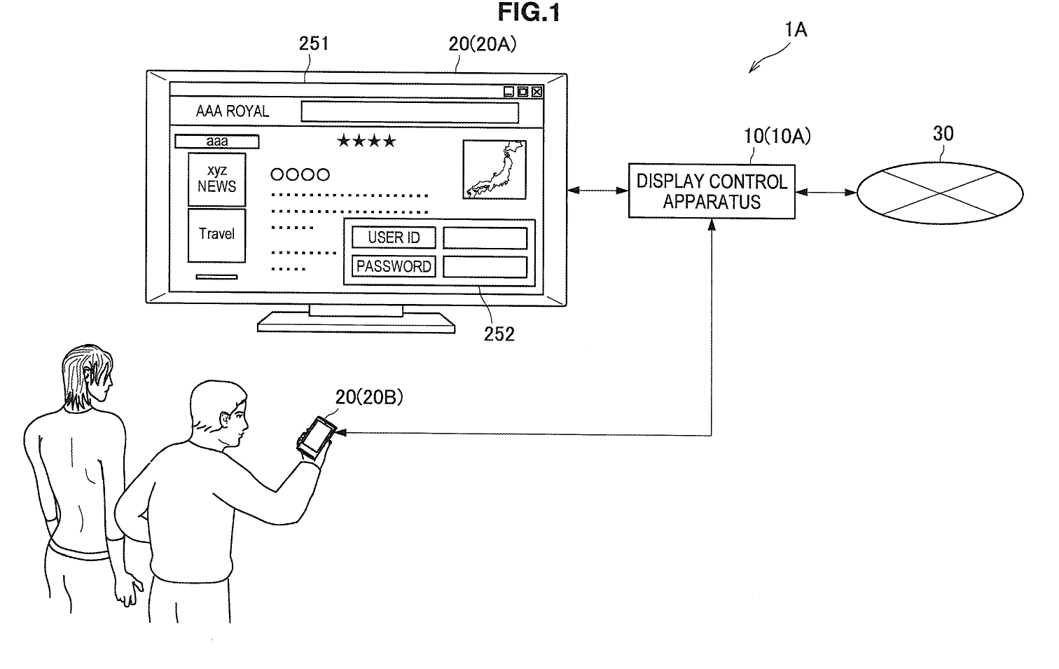

First, a configuration example of a display control system 1A according to the first embodiment will be described. FIG. 1 is a diagram showing a configuration example of the display control system 1A according to the first embodiment.

As shown in FIG. 1, the display control system 1A according to the first embodiment includes, for example, a display control apparatus 10A, a display device 20A, and a display device 20B. The display control apparatus 10A is connected to a network 30, and is mutually communicable with a server (for example, web server), which is not shown, through the network 30. It should be noted that the configuration shown in FIG. 1 is merely an example. For example, although the display control apparatus 10A is connected to the network 30 in the example shown in FIG. 1, the display control apparatus 10A may not be connected to the network 30. Further, the network 30 may be the Internet, a wireless LAN, or other networks.

The display control apparatus 10A has a function of acquiring a display target screen. For example, the display control apparatus 10A acquires the display target screen from a server (for example, web server), which is not shown, connected to the network 30, and the display control apparatus 10A may also acquire the display target screen from anywhere. The display control apparatus 10A controls the display device 20A to display the acquired display target screen. Note that, although the display control apparatus 10A is provided separately from the display device 20A in the example shown in FIG. 1, the display control apparatus 10A may be integrated into the display device 20A.

The display device 20A has a function of displaying the display target screen in accordance with the control performed by the display control apparatus 10A. The display device 20A has, for example, a display surface that is larger than a display surface of the display device 20B, and can display the display target screen on the display surface. Accordingly, for example, as shown in the example shown in FIG. 1, the display target screen displayed by the display device 20A is suitable to be looked at by multiple viewers. For example, the display device 20A may be a television device or a display apparatus.

The display device 20B is operated by an operator. For example, the display device 20B is used to be operated by the operator, who is any one of the multiple viewers looking at the display target screen of the display device 20A. However, the operator of the display device 20B may not look at the display target screen of the display device 20A. For example, the operator can operate the display device 20B without the display surface thereof being looked at by people other than the operator. For example, the display device 20B may be a smartphone or a mobile phone.

Here, as shown in FIG. 1, in the case where the display target screen is, like an entry screen 251, a screen having an entry area 252, pieces of secret information such as a user ID and a password are entered into the entry area 252. Even in the case where the password is not directly displayed, predetermined characters (such as “*”) from which the number of characters of the password can be seen may be displayed. In the case where such secret information is entered, the secret information may be seen unintendedly by a viewer. Accordingly, the first embodiment of the present disclosure suggests technology for causing the display device 20B to display the entry screen in the case where the display target screen to be displayed on the display device 20A is the entry screen.

Heretofore, the configuration example of the display control system 1A according to the first embodiment has been described. Next, a functional configuration example of the display control apparatus 10A according to the first embodiment will be described.

<1-2. Functional Configuration Example of Display Control Apparatus>

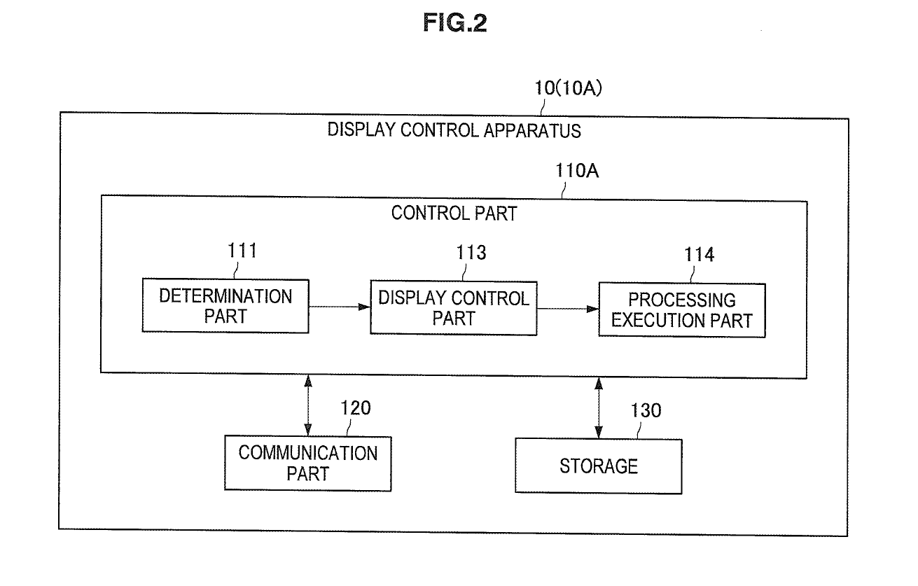

FIG. 2 is a diagram showing a functional configuration example of the display control apparatus 10A according to the first embodiment. As shown in FIG. 2, the display control apparatus 10A includes a control part 110A, a communication part 120, and a storage 130. Further, the control part 110A includes a determination part 111, a display control part 113, and a processing execution part 114.

The control part 110A corresponds to a processor such as a central processing unit (CPU) or a digital signal processor (DSP). The control part 110A executes a program stored in the storage 130 or another storage medium, and thereby exhibiting various functions of the control part 110A. The respective functions of the determination part 111, the display control part 113, and the processing execution part 114 will be described later.

The communication part 120 is a communication interface configured from, for example, a communication device for connecting to the network 30. The communication part 120 is capable of communicating with a server (for example, web server), which is not shown, through the network 30, for example. Further, the communication part 120 is capable of communicating via wire or radio with the display device 20A. Further, the communication part 120 is capable of communicating via wire or radio with the display device 20B.

The storage 130 uses semiconductor memory or a storage medium such as a hard disk, and stores a program for the processing performed by the control part 110A and data. For example, the storage 130 can store a program to be executed by the control part 110A. Further, for example, the storage 130 can also store configuration information to be used by a program. In the example shown in FIG. 2, although the storage 130 is integrated into the display control apparatus 10A, the storage 130 may be provided separately from the display control apparatus 10A.

Heretofore, the functional configuration example of the display control apparatus 10A according to the first embodiment has been described. Next, a functional configuration example of a display device 20 according to the first embodiment will be described.

<1-3. Functional Configuration Example of Display Device>

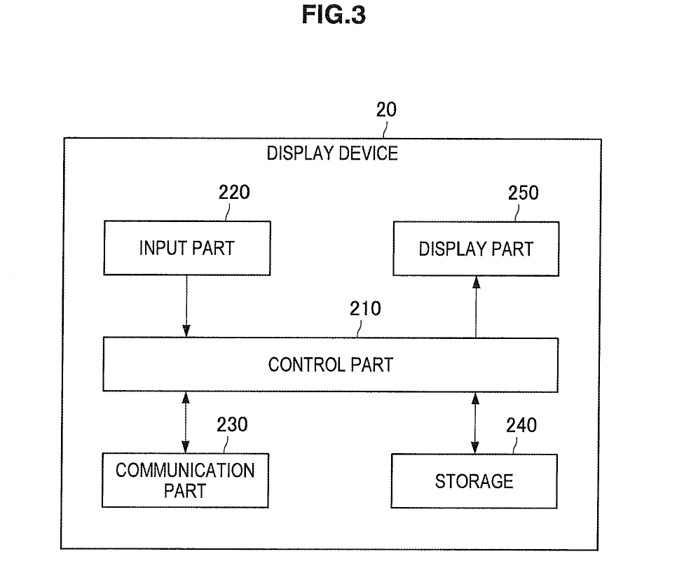

FIG. 3 is a diagram showing a functional configuration example of a display device 20 according to the first embodiment. As shown in FIG. 3, the display device 20 includes a control part 210, an input part 220, a communication part 230, a storage 240, and a display part 250.

The control part 210 corresponds to a processor such as a CPU or a DSP. The control part 210 executes a program stored in the storage 240 or another storage medium, and thereby exhibiting various functions of the control part 210.

The input part 220 has a function of accepting an operation from an operator. The input part 220 outputs, to the control part 210, the operation from the operator as operation information. The operation information is used for the execution of the program performed by the control part 210, for example. In the example shown in FIG. 3, although the input part 220 is integrated into the display device 20, the input part 220 may be provided separately from the display device 20.

The communication part 230 is capable of communicating via wire or radio with the display control apparatus 10A, for example. Further, the communication part 230 may be capable of communicating with a server (for example, web server), which is not shown, through the network 30, for example. Still further, the communication part 230 may be capable of directly communicating with another display device 20.

The storage 240 uses semiconductor memory or a storage medium such as a hard disk, and stores a program for the processing performed by the control part 210 and data. For example, the storage 240 can store a program to be executed by the control part 210. Further, for example, the storage 240 can also store configuration information to be used by a program. In the example shown in FIG. 3, although the storage 240 is integrated into the display device 20, the storage 240 may be provided separately from the display device 20.

The display part 250 has a function of displaying a screen in accordance with the control part 110 of the display control apparatus 10A. For example, the display part 250 may display a screen stored in the storage 240, may display a screen of which the display part 250 is notified by the display control apparatus 10A, or may display a screen of which the display part 250 is notified by another display device 20.

Heretofore, the functional configuration example of the display device 20 according to the first embodiment has been described. Hereinafter, details of functions of the display control apparatus 10A according to the first embodiment will be described.

<1-4. Description of Functions of Display Control Apparatus>

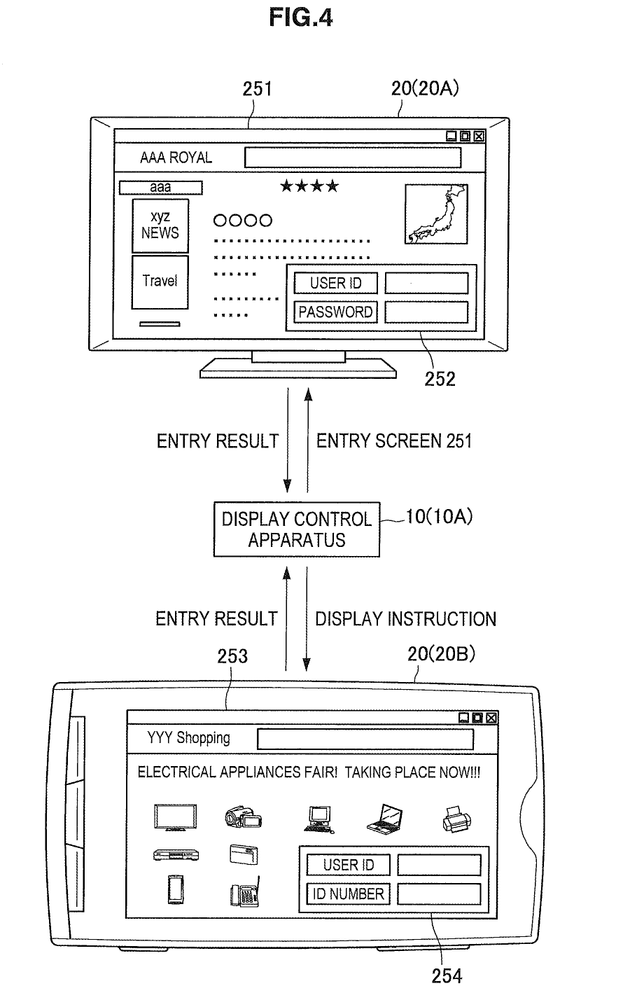

FIG. 4 is a diagram showing an example of functions of the display control apparatus 10A according to the first embodiment. First, the display control apparatus 10A acquires a display target screen. Note that, as described above, the display control apparatus 10A may acquire the display target screen from anywhere. For example, in the case where the display target screen is acquired from a server (for example, web server), which is not shown, the display target screen may be a web page. The web page may be, for example, an HTML (HyperText Markup Language) file or an XHTML (Extensible HyperText Markup Language) file.

Subsequently, the determination part 111 determines whether the acquired display target screen is an entry screen. Whether the display target screen is an entry screen may be determined in any way. For example, the display target screen may be determined to be an entry screen if an entry field is included in the entry screen. The entry screen determined by the determination part 111 may be an authentication screen for a user to enter authentication information. This is because the authentication screen is expected to have high level of confidentiality. Whether the display target screen is an authentication screen may be determined based on whether a predetermined tag (for example, <input type=“hidden”>) is included in the display target screen, for example.

In the example shown in FIG. 4, an entry screen 251 is acquired as the display target screen by the display control apparatus 10A. Accordingly, the determination part 111 determines whether the acquired entry screen 251 is an entry screen, and determines that the entry screen 251 is an entry screen. The entry screen 251 is an example of the authentication screen, and includes an entry area 252. The entry area 252 includes an entry field for a user ID and an entry field for a password, but the entry field included in the entry area 252 is not limited to those entry fields.

In the case where the determination part 111 determines that the display target screen is not an entry screen, the display control part 113 controls a display device 20A to display the display target screen. On the other hand, in the case where it is determined that the display target screen is an entry screen, the display control part 113 may control a display device 20B, which is different from the display device 20A, to display an entry screen that is the same as or different from the display target screen.

In the case where the display control apparatus 10A performs notification of an instruction to display an entry screen that is the same as or different from the display target screen, the communication part 230 of the display device 20B receives the instruction from the display control apparatus 10A. In the case where the instruction to display an entry screen that is the same as or different from the display target screen is received by the communication part 230, the display part 250 of the display device 20B displays the entry screen.

In the example shown in FIG. 4, since the determination part 111 determines that the entry screen 251 is an entry screen, the display control part 113 notifies the display device 20B of the instruction to display an entry screen 253 that is different from the entry screen 251. In this way, the display control part 113 notifies the display device 20B of the display instruction, and thereby controlling the display device 20B to display the entry screen 253.

In the example shown in FIG. 4, the entry screen 253 includes an entry area 254, and the entry area 254 includes an entry field for a user ID and an entry field for an identification number. However, the entry field included in the entry area 254 is not limited to those entry fields. Note that assumed in this example is the case where the entry screen 251 and the entry screen 253 are different from each other. It should be noted that the display control part 113 may perform the control in a manner that the number of entry fields included in the entry screen 251 is the same as the number of entry fields included in the entry screen 253. Further, the entry screen 251 and the entry screen 253 may be the same as each other.

Note that, in the example shown in FIG. 4, the display control part 113 controls the display device 20B to display the entry screen 253, and also controls the display device 20A to display the entry screen 251. In the case of performing such control, data entry into the entry screen 251 is available, and data entry into the entry screen 253 is also available. For example, in the case where an operator does not want to allow a viewer other than the operator see an entry result, it is expected that the data entry into the entry screen 253 is performed through the input part 220 of the display device 20B. On the other hand, for example, in the case where the operator does not mind allowing a viewer other than the operator see the entry result, it is expected that the data entry into the entry screen 251 is performed through the input part 220 of the display device 20A.

Subsequently, the processing execution part 114 executes processing based on the entry result on the entry screen 251 or the entry screen 253. For example, in the case where the entry result on the entry screen 251 is acquired from the display device 20A, the processing execution part 114 may execute processing based on the entry result on the entry screen 251. Further, for example, in the case where the entry result on the entry area 252 is acquired from the display device 20B, the processing execution part 114 may execute processing based on the entry result on the entry screen 253.

The processing executed by the processing execution part 114 is not particularly limited. For example, the processing execution part 114 may perform control in a manner that the entry result is transmitted to a server (for example, web server), which is not shown, the server having transmitted the display target screen. In the case where the entry result on the entry screen 251 or the entry screen 253 is acquired, the authentication processing with respect to the entry result may be executed by the server.

Further, in the case where both the entry result on the entry screen 251 and the entry result on the entry screen 253 are acquired, the processing execution part 114 may select any one of the entry results, and may execute the processing based on the selected entry result. Which of the entry results is to be selected may be decided in advance, or the entry result that is acquired earlier than the other may be selected.

Note that, in the display device 20B, in the case where an application for performing data entry into the entry screen 253 is not active, it is expected that the entry result on the entry screen 253 is not transmitted to the display control apparatus 10A. Accordingly, in this case, the display control part 113 may control the display device 20B to display information for prompting to activate the application for performing data entry into the entry screen 253.

The configuration shown in FIG. 4 realizes technology for causing the display device 20B to display an entry screen, the display device 20B being different from the display device 20A displaying a screen other than the entry screen. Accordingly, in the case where an operator does not want to allow a viewer other than the operator see an entry result, for example, the operator can perform data entry into the entry screen displayed by the display device 20B.

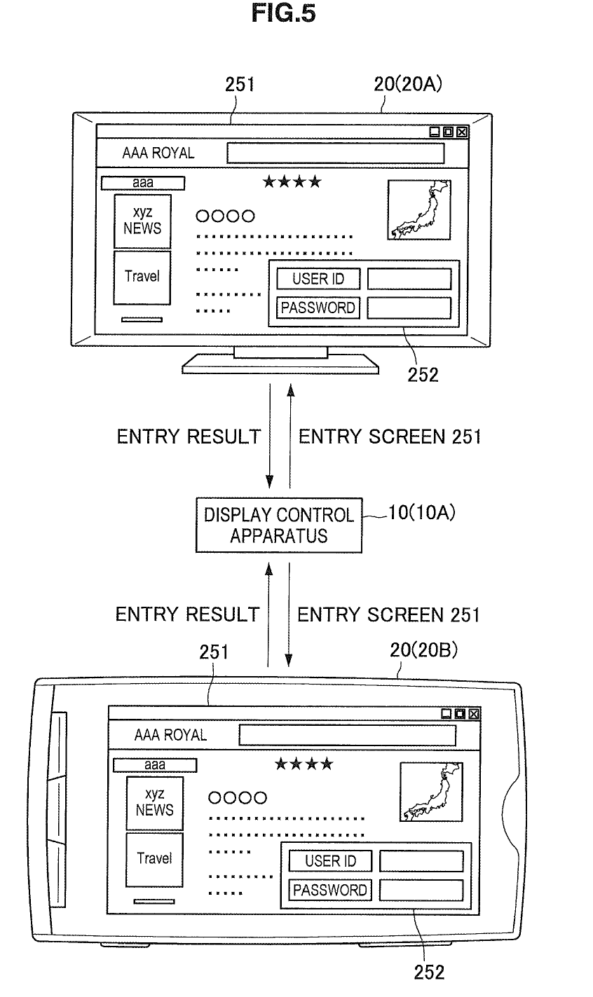

FIG. 5 is a diagram showing an example of functions of the display control apparatus 10A according to the first embodiment. Of the example shown in FIG. 5, the matters that differ from the example shown in FIG. 4 will be mainly described. That is, in the example shown in FIG. 5, the following is different from the example shown in FIG. 4: the display control part 113 notifies the display device 20B of the entry screen 251. The display device 20B displays the entry screen 251 of which the display device 20B is notified.

According to the configuration shown in FIG. 5, since the entry screen 251 acquired by the display control apparatus 10A is displayed on the display device 20B, it is expected that the awkwardness is reduced, which is felt by the operator performing data entry into the entry screen displayed on the display device 20B. Note that the size of the entry screen 251 displayed on the display device 20B may be reduced by the display control part 113 or the display device 20B.

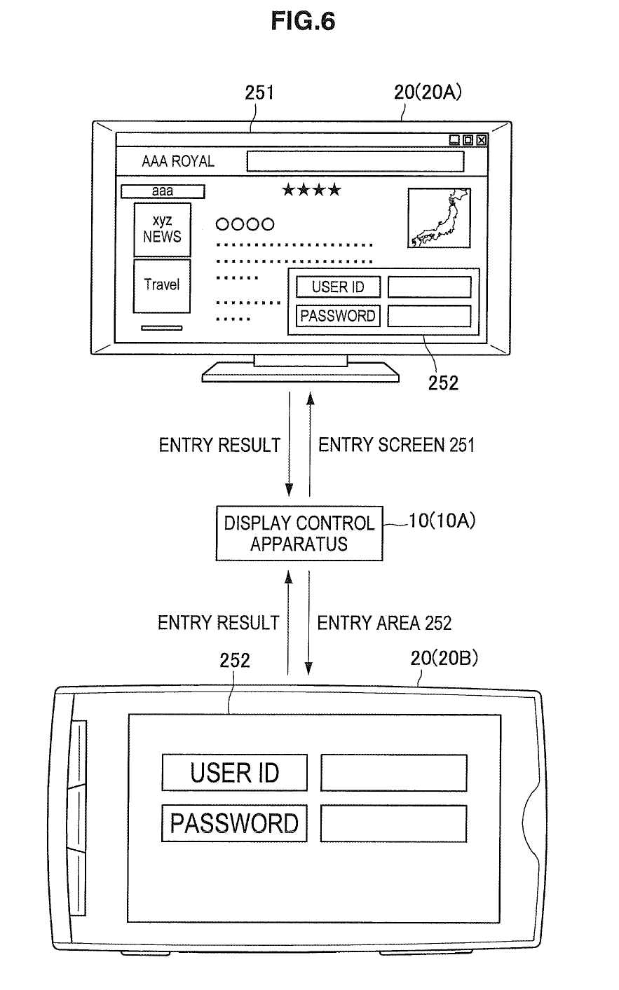

FIG. 6 is a diagram showing an example of functions of the display control apparatus 10A according to the first embodiment. Of the example shown in FIG. 6, the matters that differ from the example shown in FIG. 5 will be mainly described. That is, in the example shown in FIG. 6, the following is different from the example shown in FIG. 5: the display control part 113 extracts the entry area 252 that is present in the entry screen 251 and notifies the display device 20B of the entry area 252. The display device 20B displays the entry area 252 of which the display device 20B is notified.

According to the configuration shown in FIG. 6, since the entry area 252 included in the entry screen 251 acquired by the display control apparatus 10A is displayed on the display device 20B, it is expected that the size of data of which the display device 20B is notified is reduced. Note that the size of the entry area 252 displayed on the display device 20B may be reduced by the display control part 113 or the display device 20B.

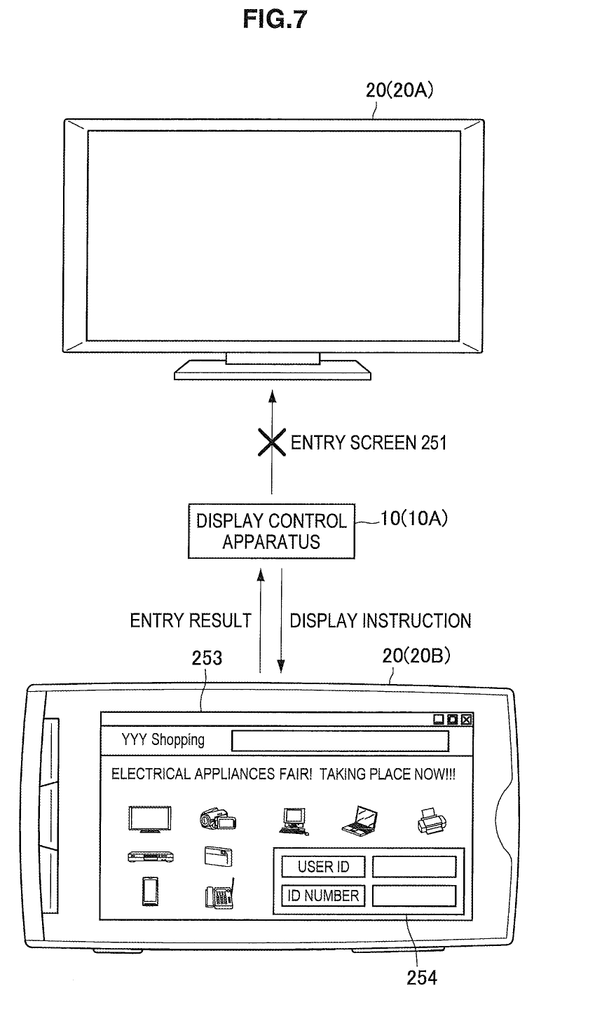

FIG. 7 is a diagram showing an example of functions of the display control apparatus 10A according to the first embodiment. Of the example shown in FIG. 7, the matters that differ from the example shown in FIG. 4 will be mainly described. That is, in the example shown in FIG. 7, the following is different from the example shown in FIG. 4: in the case where it is determined that the display target screen is the entry screen 251, the display control part 113 restricts the display of the display target screen on the display device 20A. For example, the display control part 113 may prohibit the display of the display target screen on the display device 20A.

Further, in the case where the display of the display target screen on the display device 20A is restricted in this way, it is expected that there is a case where data entry into the entry screen 253 is not performed and an entry result is not acquired from the display device 20B for a period of time exceeding a predetermined time period. Accordingly, in the case where the period of time for which data entry into the entry screen 253 is not performed has exceeded the predetermined time period, the display control part 113 may control the display device 20A to display the display target screen.

According to the configuration shown in FIG. 7, since the display of the entry screen 251 on the display device 20A can be restricted, the entry screen 251 can be prevented from being looked at, for example. Further, in the case where it is difficult to perform data entry on the entry screen 253 of the display device 20B, it is also possible to perform data entry into the entry screen 251 by causing the display device 20A to display the entry screen 251.

Heretofore, the details of functions of the display control apparatus 10A according to the first embodiment have been described. Hereinafter, an operation example of the display control apparatus 10A according to the first embodiment will be described.

<1-5. Operation Example of Display Control Apparatus>

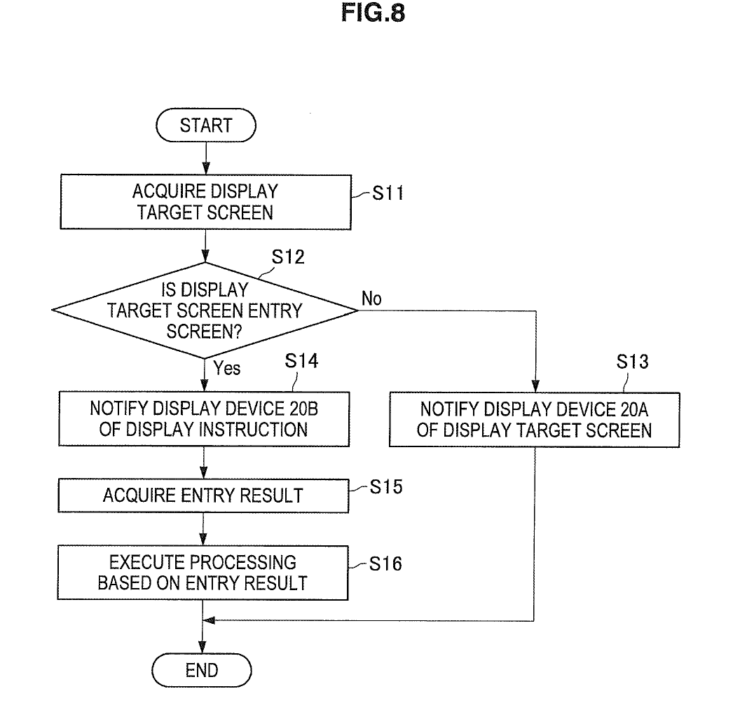

FIG. 8 is a diagram showing an operation example of the display control apparatus 10A according to the first embodiment. Note that, since the operation shown in FIG. 8 is merely an example of operation of the display control apparatus 10A according to the first embodiment, the operation of the display control apparatus 10A according to the first embodiment is not limited to the operation shown in FIG. 8.

As shown in FIG. 8, first, when a display target screen is acquired (S11), the determination part 111 determines whether the display target screen is an entry screen (S12). As described above, the entry screen may be an authentication screen. In the case where it is determined that the display target screen is not an entry screen (“No” in S12), the display control part 113 notifies the display device 20A of the display target screen (S13). In this way, by notifying the display device 20A of the display target screen, the display control part 113 can control the display device 20A to display the display target screen.

On the other hand, in the case where it is determined that the display target screen is an entry screen (“Yes” in S12), the display control part 113 notifies the display device 20B, which is different from the display device 20A, of a display instruction to display an entry screen that is the same as or different from the display target screen (S14). As described above, the display instruction may be a display target screen itself, may be an entry area extracted from the display target screen, or may be another instruction. In this way, by notifying the display device 20B of the display instruction, the display control part 113 can control the display device 20B to display an entry screen that is the same as or different from the display target screen.

When an entry result on the display target screen displayed by the display device 20A or the entry screen displayed by the display device 20B is acquired (S15), the processing execution part 114 executes processing based on the entry result (S16). As described above, in the case where both the entry result on the display target screen and the entry result on the entry screen are acquired, the processing execution part 114 may select any one of the entry results, and may execute the processing based on the selected entry result.

According to the operation as described above, in the case where the display device 20A displays a screen other than an entry screen, and in the case where the display target screen is an entry screen, it is possible to cause the display device 20B, which is different from the display device 20A, to display the entry screen that is the same as or different from the display target screen.

Heretofore, the first embodiment has been described.

### 2. Second Embodiment

Next, a second embodiment will be described. The second embodiment mainly differs from the first embodiment in that functions of a display control apparatus 10B are different from functions of the display control apparatus 10A. Accordingly, in the second embodiment to be described below, the description will be mainly made of a functional configuration example of the display control apparatus 10B.

<2-1. Configuration Example of Display Control System>

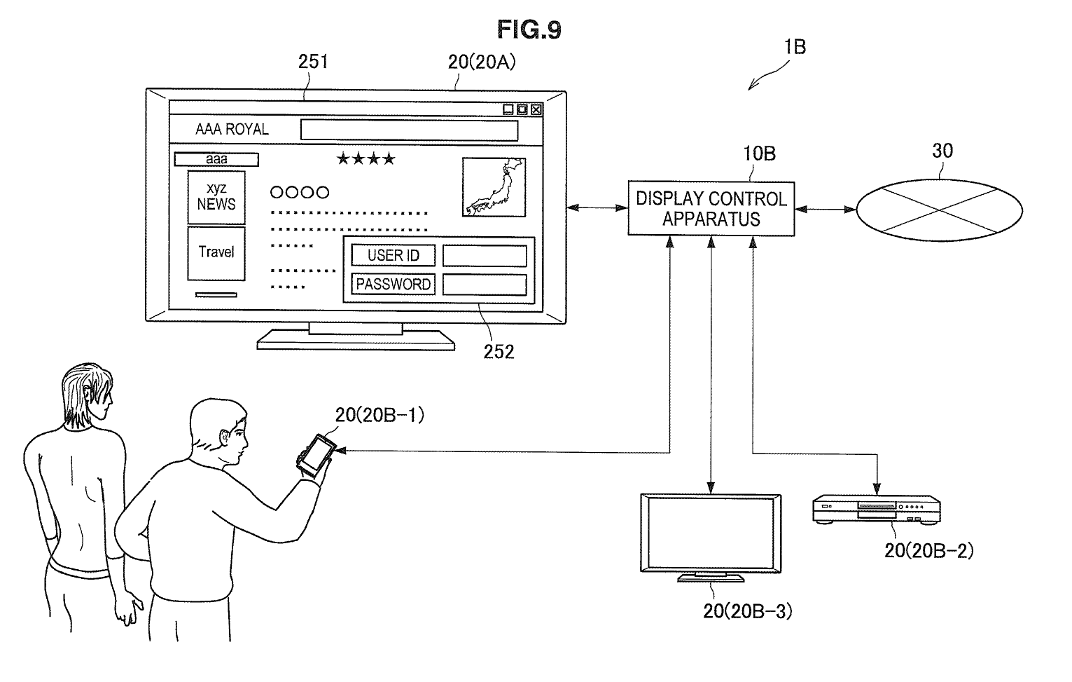

FIG. 9 is a diagram showing a configuration example of a display control system 1B according to the second embodiment. As shown in FIG. 9, the display control system 1B according to the second embodiment includes, for example: a display control apparatus 10B; a display device 20A; and a display device 20B-1, a display device 20B-2, and a display device 20B-3 each serving as a candidate for a display device 20B. In the example shown in FIG. 9, there are three candidates for the display device 20B, but the number of candidates for the display device 20B is not particularly limited.

Heretofore, the configuration example of the display control system 1B according to the second embodiment has been described. Next, a functional configuration example of the display control apparatus 10B according to the second embodiment will be described.

<2-2. Functional Configuration Example of Display Control Apparatus>

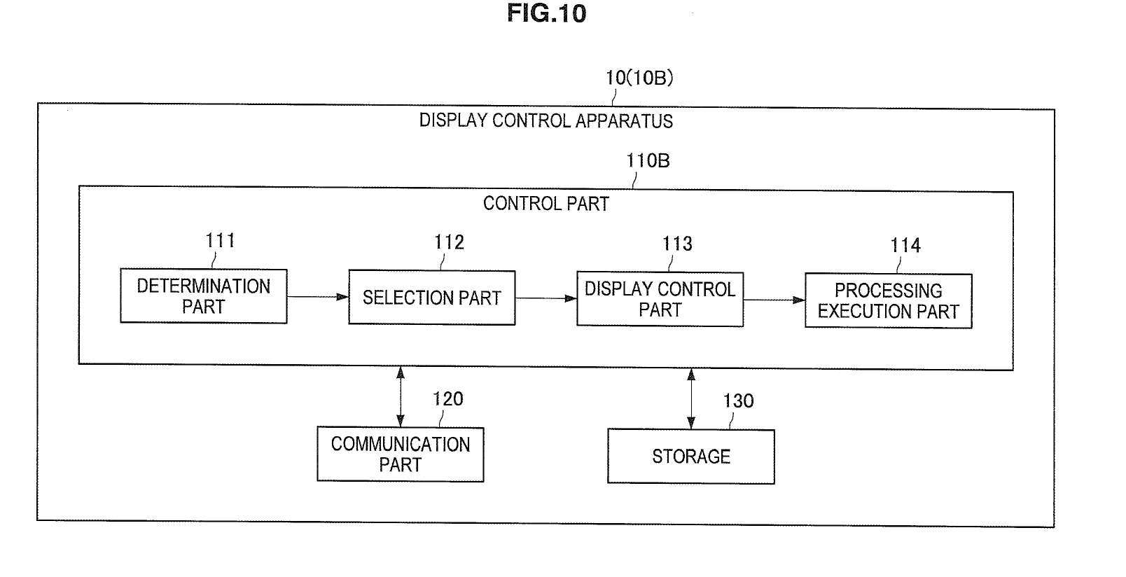

FIG. 10 is a diagram showing a functional configuration example of the display control apparatus 10B according to the second embodiment. As shown in FIG. 10, the display control apparatus 10B includes a control part 110B, a communication part 120, and a storage 130. Further, the control part 110B includes a determination part 111, a selection part 112, a display control part 113, and a processing execution part 114. The control part 110B of the display control apparatus 10B differs from the control part 110A of the display control apparatus 10A in that the control part 110B of the display control apparatus 10B includes the selection part 112.

In the first embodiment, the description has been made of the example in which the display device 20B is decided in advance. In the second embodiment, in the case where there are multiple candidates for the display device 20B, the display device 20B is selected from the multiple candidates. That is, in the case where there are multiple candidates for the display device 20B, the selection part 112 has a function of selecting the display device 20B from the multiple candidates. This is because it is preferred that the display device 20B that is suitable for display of an entry screen be selected from the multiple candidates. Hereinafter, details of functions of the selection part 112 will be described.

<2-3. Description of Functions of Display Control Apparatus>

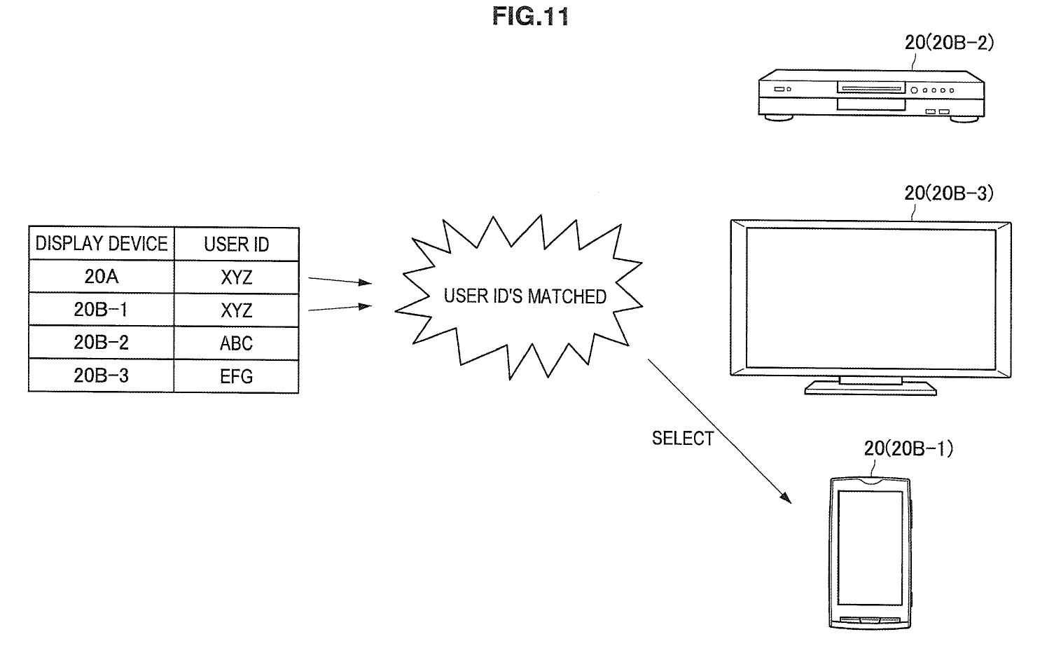

FIG. 11 is a diagram showing an example of functions of the selection part 112 according to the second embodiment. Particularly in FIG. 11, an example is shown in which, when there is a display device associated with a user ID that matches a user ID associated with the display device 20A, the selection part 112 selects the display device as the display device 20B.

In the example shown in FIG. 11, since the user ID associated with the display device 20A is “XYZ” and the user ID associated with a display device 20B-1 is “XYZ”, the user ID associated with the display device 20A matches the user ID associated with the display device 20B-1. Accordingly, in this example, the selection part 112 selects the display device 20B-1 as the display device 20B.

The reason for such selection being performed is as follows. Even in the case where multiple viewers are looking at the display device 20A, there may often be situations where a user himself/herself of the display device 20A performs data entry into the entry screen. Accordingly, as described above, when the display device associated with the user ID that matches the user ID associated with the display device 20A is selected as the display device 20B, the entry screen can be displayed on a more suitable display device.

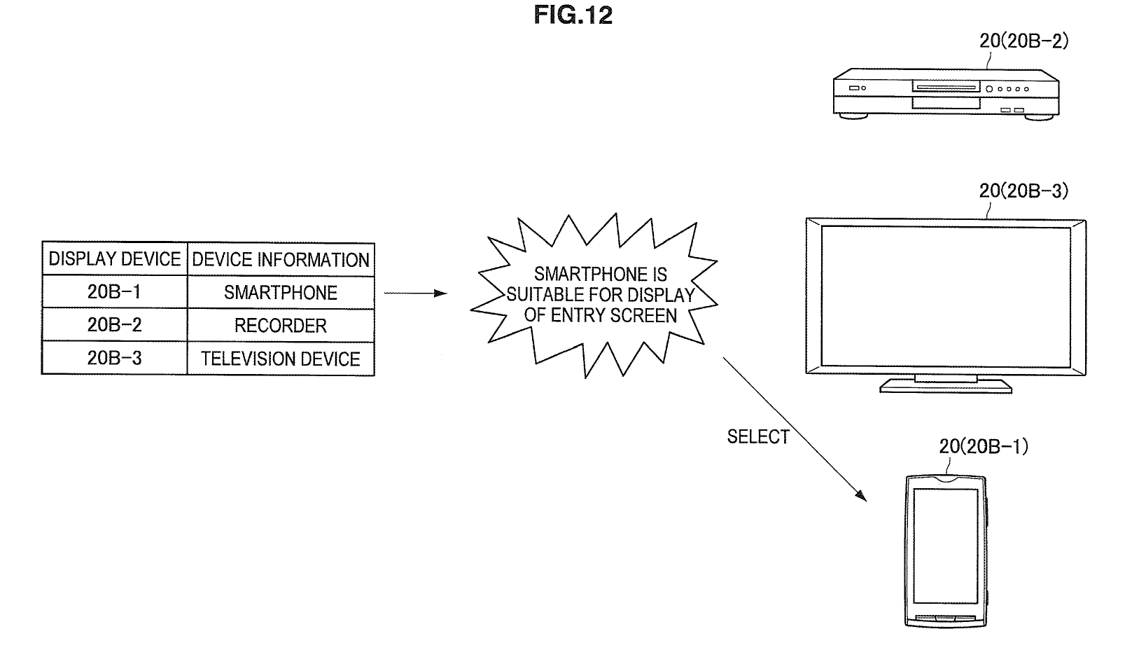

FIG. 12 is a diagram showing an example of functions of the selection part 112 according to the second embodiment. Particularly in FIG. 12, an example is shown in which the selection part 112 selects a display device 20B from multiple candidates based on device information of each of the multiple candidates. As the example shown in FIG. 12, the device information may be information indicating the type of the device, for example. Further, the device information may also be the model number of the device.

In the example shown in FIG. 12, the device information of the display device 20B-1 is “smartphone”, the device information of the display device 20B-2 is “recorder”, and the device information of the display device 20B-3 is “television device”. Accordingly, in this example, the selection part 112 selects the display device 20B-1 having the device information of “smartphone”, which is suitable for displaying an entry screen, as the display device 20B.

The reason for such selection being performed is as follows. It is considered that there are devices which are suitable for displaying entry screens and devices which are not suitable for displaying entry screens. For example, in the case where an entry screen is displayed on a device like “television device” that is used by multiple viewers, it is difficult to say that “television device” is suitable for displaying an entry screen, because the entry result is easily seen by others. Further, for example, it is difficult to say that it is easy to perform data entry operation on a device like “recorder” even though the device has a function of displaying an entry screen.

Accordingly, a device like “smartphone” that is a personal device which it is difficult to be looked into by others and that is a device into which it is easy to perform data entry is suitable for displaying an entry screen, for example. The device information indicating a device suitable for displaying an entry screen may be registered in advance. In this way, when the device suitable for displaying an entry screen is selected as the display device 20B, it becomes possible to cause a more suitable display device to display an entry screen.

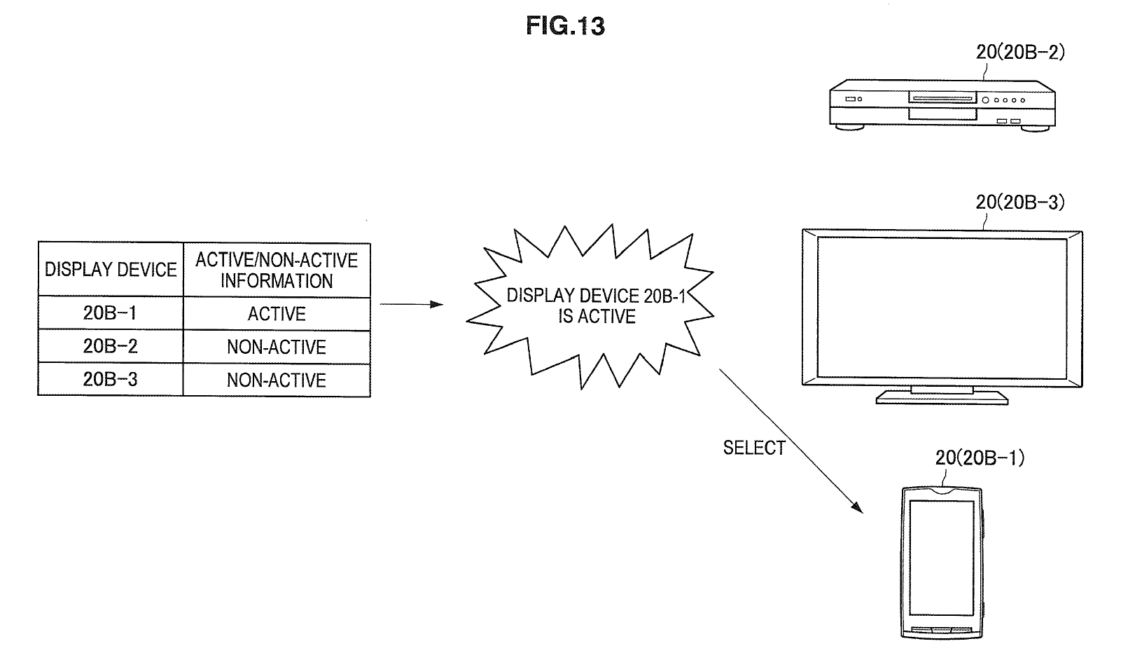

FIG. 13 is a diagram showing an example of functions of the selection part 112 according to the second embodiment. Particularly in FIG. 13, an example is shown in which, when there is an active display device included in the multiple candidates, the selection part 112 selects the display device as the display device 20. The active display device may be a display device in a power-on state, or may be a display device which is not in a quiescent state.

In the example shown in FIG. 13, the display device 20B-1 is “active”, the display device 20B-2 is in “non-active” state, and the display device 20B-3 is in “non-active” state. Accordingly, in this example, the selection part 112 selects the display device 20B-1 which is “active” as the display device 20B. Whether a display device is active may be determined in any way. For example, if a display device responds to a request for checking whether the display device is active, the display device may be determined to be active.

The reason for such selection being performed is as follows. It is considered that a display device which is not active is not able to display an entry screen. Accordingly, the selection part 112 may select an “active” display device as the display device 20B. In this way, when the active display device is selected as the display device 20B, it becomes possible to cause a more suitable display device to display an entry screen.

In addition thereto, there are various techniques for the selection performed by the selection part 112. For example, the selection part 112 may also select a display device 20B from multiple candidates based on information on an application that is active on each of the multiple candidates. For example, when an application having a function of transmitting an entry result on an entry screen to the display control apparatus 10B is not active, the entry result is not sent back to the display control apparatus 10B even if data entry into the entry screen is performed.

Accordingly, for example, the selection part 112 may select as the display device 20B the display device in which an application is active, the application having the function of transmitting an entry result to the display control apparatus 10B. For example, in the case where the selection part 112 grasps in advance an application having such a function, the selection part 112 may determine whether the application is active in each display device.

Further, for example, the selection part 112 may also select a display device 20B from multiple candidates based on information which has been set in advance. For example, in the case where the display device 20B-1 has been set in advance as the display device 20B, the selection part 112 can select the display device 20B-1 as the display device 20B based on the information which has been set in advance. Note that, in the case where there are multiple candidates, the number of display devices 20B selected from the multiple candidates may not be one. For example, multiple display devices 20B may be selected from the multiple candidates, or all the multiple candidates may each be selected as the display device 20B.

Heretofore, the example of functions of the selection part 112 has been described. Next, an operation example of the display control apparatus 10B according to the second embodiment will be described.

<2-4. Operation Example of Display Control Apparatus>

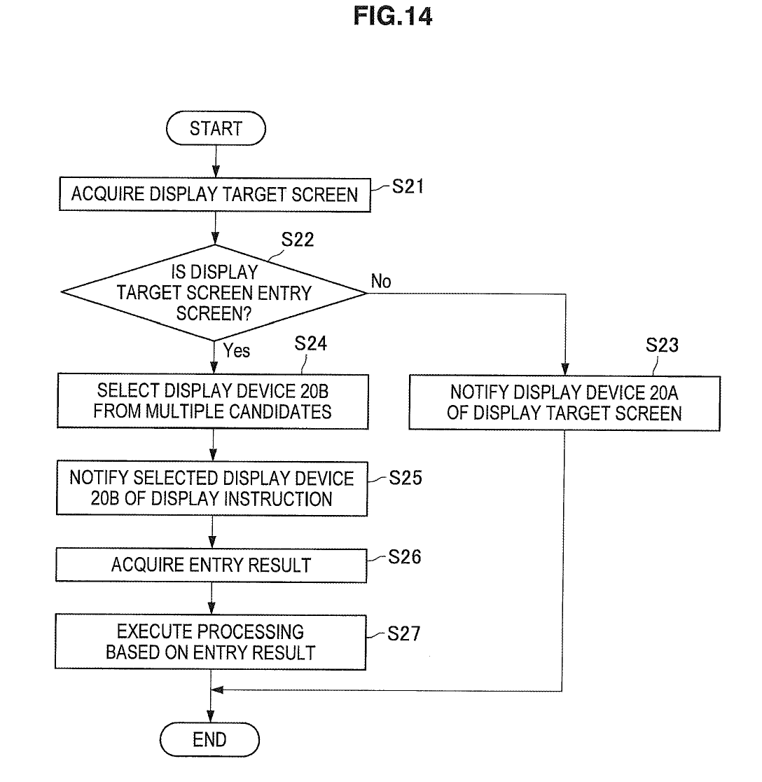

FIG. 14 is a flowchart showing an operation flow of the display control apparatus 10B according to the second embodiment. Note that, since the operation shown in FIG. 14 is merely an example of operation of the display control apparatus 10B according to the second embodiment, the flow of the operation of the display control apparatus 10B according to the second embodiment is not limited to the operation flow of the operation shown in FIG. 14.

As shown in FIG. 14, first, when a display target screen is acquired (S21), the determination part 111 determines whether the display target screen is an entry screen (S22). As described above, the entry screen may be an authentication screen. In the case where it is determined that the display target screen is not an entry screen (“No” in S22), the display control part 113 notifies the display device 20A of the display target screen (S23). In this way, by notifying the display device 20A of the display target screen, the display control part 113 can control the display device 20A to display the display target screen.

On the other hand, in the case where it is determined that the display target screen is an entry screen (“Yes” in S22), the selection part 112 selects a display device 20B from multiple candidates (S24), and the display control part 113 notifies the display device 20B of a display instruction to display an entry screen that is the same as or different from the display target screen (S25). As described above, the display instruction may be a display target screen itself, may be an entry area extracted from the display target screen, or may be another instruction. In this way, by notifying the display device 20B of the display instruction, the display control part 113 can control the display device 20B, which is selected from the multiple candidates, to display an entry screen that is the same as or different from the display target screen.

When an entry result on the display target screen displayed by the display device 20A or the entry screen displayed by the display device 20B is acquired (S26), the processing execution part 114 executes processing based on the entry result (S27). As described above, in the case where both the entry result on the display target screen and the entry result on the entry screen are acquired, the processing execution part 114 may select any one of the entry results, and may execute the processing based on the selected entry result.

According to the operation as described above, in the case where the display device 20A displays a screen other than an entry screen, and in the case where the display target screen is an entry screen, it is possible to cause the display device 20B, which is selected from the multiple candidates, to display the entry screen that is the same as or different from the display target screen.

Heretofore, the second embodiment has been described.

### 3. Conclusion

As described above, according to the embodiments of the present disclosure, there is provided a display control apparatus including a determination part configured to determine whether a display target screen is an entry screen, and a display control part configured to, in a case where the display target screen is determined not to be an entry screen, control a first display device to display the display target screen, and in a case where the display target screen is determined to be an entry screen, control a second display device, which is different from the first display device, to display an entry screen that is identical to or different from the display target screen.

Such a configuration can realize technology for causing a display device to display an entry screen, the display device being different from a display device displaying a screen other than the entry screen.

It should be understood by those skilled in the art that various modifications, combinations, sub-combinations and alterations may occur depending on design requirements and other factors insofar as they are within the scope of the appended claims or the equivalents thereof.

Further, the respective steps included in the operation of the display control system 1 according to the present specification are not necessarily processed in a time-series order in accordance with the flowcharts. For example, the respective steps included in the operation of the display control system 1 may be executed in a different order from that described in the flowchart or may be executed in a parallel manner.

Further, it is also possible to create a computer program for causing hardware such as a CPU, ROM, and RAM, which are built in the display control apparatus 10, to exhibit equivalent functions as those of structures of the display control apparatus 10 described above. Further, there is also provided a storage medium having the computer program stored therein.

In the same manner, it is also possible to create a computer program for causing hardware such as a CPU, ROM, and RAM, which are built in the display device 20, to exhibit equivalent functions as those of structures of the display device 20 described above. Further, there is also provided a storage medium having the computer program stored therein.

Additionally, the present technology may also be configured as below.
(1) A display control apparatus including:

a determination part configured to determine whether a display target screen is an entry screen; and

a display control part configured to, in a case where the display target screen is determined not to be an entry screen, control a first display device to display the display target screen, and in a case where the display target screen is determined to be an entry screen, control a second display device, which is different from the first display device, to display an entry screen that is identical to or different from the display target screen.
(2) The display control apparatus according to (1),

wherein the determination part determines whether the display target screen is an authentication screen into which authentication information is to be entered.
(3) The display control apparatus according to (1) or (2),

wherein, in a case where there are a plurality of candidates for the second display device, the display control apparatus includes a selection part configured to select the second display device from the plurality of candidates.
(4) The display control apparatus according to (3),

wherein, in a case where there is a display device associated with user identification information that matches user identification information associated with the first display device, the selection part selects the display device as the second display device.
(5) The display control apparatus according to (3),

wherein the selection part selects the second display device from the plurality of candidates based on information which has been set in advance.
(6) The display control apparatus according to (3),

wherein the selection part selects the second display device from the plurality of candidates based on device information of each of the plurality of candidates.
(7) The display control apparatus according to (3),

wherein the selection part selects the second display device from the plurality of candidates based on information on an application that is active on each of the plurality of candidates.
(8) The display control apparatus according to (3),

wherein, in a case where a display device that is active is included in the plurality of candidates, the selection part selects the display device as the second display device.
(9) The display control apparatus according to any one of (1) to (8),

wherein, in a case where an application for performing data entry into the entry screen is not active in the second display device, the display control part controls the second display device to display information for prompting to activate the application. (
10) The display control apparatus according to any one of (1) to (9),

wherein, in a case where the display target screen is determined to be an entry screen, the display control part restricts display of the display target screen on the first display device.
(11) The display control apparatus according to (10),

wherein, in a case where a period of time for which data entry into the entry screen is not performed has exceeded a predetermined time period in the second display device, the display control part controls the first display device to display the display target screen.
(12) The display control apparatus according to any one of (1) to (11), further including

a processing execution part configured to execute processing based on an entry result on the display target screen of the first display device or an entry result on the entry screen of the second display device.
(13) The display control apparatus according to any one of (1) to (12),

wherein the display control part controls the second display device to display the entry screen by notifying the second display device of an instruction to display the entry screen.
(14) The display control apparatus according to (13),

wherein the display control part notifies the second display device of the display target screen as the instruction to display the entry screen.
(15) The display control apparatus according to (13),

wherein the display control part extracts an entry area that is present in the display target screen, and notifies the second display device of the entry area as the instruction to display the entry screen.
(16) A display control method including:

determining whether a display target screen is an entry screen; and

in a case where the display target screen is determined not to be an entry screen, controlling a first display device to display the display target screen, and in a case where the display target screen is determined to be an entry screen, controlling a second display device, which is different from the first display device, to display an entry screen that is identical to or different from the display target screen.
(17) A program for causing a computer to function as a display control apparatus, the display control apparatus including

a determination part configured to determine whether a display target screen is an entry screen, and

a display control part configured to, in a case where the display target screen is determined not to be an entry screen, control a first display device to display the display target screen, and in a case where the display target screen is determined to be an entry screen, control a second display device, which is different from the first display device, to display an entry screen that is identical to or different from the display target screen.
(18) A display device including:

a reception part configured to, in a case where a display control apparatus determines that a display target screen is an entry screen, receive from the display control apparatus an instruction to display an entry screen that is identical to or different from the display target screen; and

a display part configured to, in a case where the instruction to display the entry screen is received by the reception part, display the entry screen.

The present disclosure contains subject matter related to that disclosed in Japanese Priority Patent Application JP 2012-080990 filed in the Japan Patent Office on Mar. 30, 2012, the entire content of which is hereby incorporated by reference.

What is claimed is:

1. A display control apparatus comprising:
a determination part configured to determine whether a display target screen is an entry screen; and
a display control part configured to, in a case where the display target screen is determined not to be an entry screen, control a first display device to display the display target screen, and in a case where the display target screen is determined to be an entry screen, control a second display device, which is different from the first display device, to display an entry screen that is identical to or different from the display target screen.

2. The display control apparatus according to claim 1,
wherein the determination part determines whether the display target screen is an authentication screen into which authentication information is to be entered.

3. The display control apparatus according to claim 1,
wherein, in a case where there are a plurality of candidates for the second display device, the display control apparatus includes a selection part configured to select the second display device from the plurality of candidates.

4. The display control apparatus according to claim 3,
wherein, in a case where there is a display device associated with user identification information that matches user identification information associated with the first display device, the selection part selects the display device as the second display device.

5. The display control apparatus according to claim 3,
wherein the selection part selects the second display device from the plurality of candidates based on information which has been set in advance.

6. The display control apparatus according to claim 3,
wherein the selection part selects the second display device from the plurality of candidates based on device information of each of the plurality of candidates.

7. The display control apparatus according to claim 3,
wherein the selection part selects the second display device from the plurality of candidates based on information on an application that is active on each of the plurality of candidates.

8. The display control apparatus according to claim 3,
wherein, in a case where a display device that is active is included in the plurality of candidates, the selection part selects the display device as the second display device.

9. The display control apparatus according to claim 1,
wherein, in a case where an application for performing data entry into the entry screen is not active in the second display device, the display control part controls the second display device to display information for prompting to activate the application.

10. The display control apparatus according to claim 1,
wherein, in a case where the display target screen is determined to be an entry screen, the display control part restricts display of the display target screen on the first display device.

11. The display control apparatus according to claim 10,
wherein, in a case where a period of time for which data entry into the entry screen is not performed has exceeded a predetermined time period in the second display device, the display control part controls the first display device to display the display target screen.

12. The display control apparatus according to claim 1, further comprising
a processing execution part configured to execute processing based on an entry result on the display target screen of the first display device or an entry result on the entry screen of the second display device.

13. The display control apparatus according to claim 1,
wherein the display control part controls the second display device to display the entry screen by notifying the second display device of an instruction to display the entry screen.

14. The display control apparatus according to claim 13,
wherein the display control part notifies the second display device of the display target screen as the instruction to display the entry screen.

15. The display control apparatus according to claim 13,
wherein the display control part extracts an entry area that is present in the display target screen, and notifies the second display device of the entry area as the instruction to display the entry screen.

16. A display control method comprising:
determining whether a display target screen is an entry screen; and
in a case where the display target screen is determined not to be an entry screen, controlling a first display device to display the display target screen, and in a case where the display target screen is determined to be an entry screen, controlling a second display device, which is different from the first display device, to display an entry screen that is identical to or different from the display target screen.

17. A program for causing a computer to function as a display control apparatus, the display control apparatus including
a determination part configured to determine whether a display target screen is an entry screen, and
a display control part configured to, in a case where the display target screen is determined not to be an entry screen, control a first display device to display the display target screen, and in a case where the display target screen is determined to be an entry screen, control a second display device, which is different from the first display device, to display an entry screen that is identical to or different from the display target screen.

18. A display device comprising:
a reception part configured to, in a case where a display control apparatus determines that a display target screen is an entry screen, receive from the display control apparatus an instruction to display an entry screen that is identical to or different from the display target screen; and
a display part configured to, in a case where the instruction to display the entry screen is received by the reception part, display the entry screen.
